(19) United States
(12) Patent Application Publication
(10) Pub. No.: US 2018/0279164 A1
(43) Pub. Date: Sep. 27, 2018

(54) CONGESTION INFORMATION TRANSMISSION TERMINAL DEVICE, CONGESTION SITUATION EVALUATION SYSTEM, CONGESTION SITUATION EVALUATION METHOD, AND RECORDING MEDIUM STORING CONGESTION INFORMATION TRANSMISSION PROGRAM

(71) Applicant: NEC Corporation, Tokyo (JP)

(72) Inventor: Hiroshi MIYAI, Tokyo (JP)

(73) Assignee: NEC Corporation, Tokyo (JP)

(21) Appl. No.: 15/914,103

(22) Filed: Mar. 7, 2018

(30) Foreign Application Priority Data
Mar. 23, 2017 (JP) 2017-057746

(51) Int. Cl. H04W 28/02; H04W 24/08; H04L 12/801; H04W 4/02

(52) U.S. Cl. CPC H04W 28/0284; H04W 4/02; H04L 47/11; H04W 24/08

(57) ABSTRACT

A congestion information transmission terminal device 40 includes a location information acquisition unit 41 for acquiring location information 410 indicating a location of an own device, an output unit 43 for outputting input request information 430 for prompting a user to input congestion information 420 indicating a result of an evaluation performed by the user with respect to a congestion situation of people around, a congestion information acquisition unit 42 for acquiring the congestion information 420 by the user's input operation in response to the input request information 430, and a transmission unit 46 for transmitting the location information 410 acquired by the location information acquisition unit 41 and the congestion information 420 acquired by the congestion information acquisition unit 42 to a congestion situation evaluation device 50 for evaluating a congestion situation related to communication environment.

This application is based upon and claims the benefit of priority from Japanese Patent Application No. 2017-057746, filed on Mar. 23, 2017, the disclosure of which is incorporated herein in its entirety by reference.

### TECHNICAL FIELD

The invention of the present application relates to a technology for collecting and evaluating information indicating a congestion situation related to communication environment.

### BACKGROUND ART

In recent years, information terminal devices such as a smart phone, a tablet terminal device, a wearable terminal device, and the like are rapidly becoming widely used. Further, because an area in which a public wireless LAN (Local Area Network) or the like can be used is being expanded and other reasons occur, a communication environment in which these information terminal devices can be used is being improved rapidly. By collecting information related to communication performed by these information terminal devices, for example, information indicating a congestion situation of people, that is, a congestion situation or the like for each area or each time with respect to the communication environment can be collected. For example, a mobile phone business operator, an ASP (Application Service Provider), or the like utilizes the collected information indicating the congestion situation and thereby, can provide a useful and high quality service to a user. Accordingly, expectation of a technology for efficiently collecting and utilizing information indicating such congestion situation rises.

As a technology related to such technology, in patent literature 1 (Japanese Patent Application Laid-Open No. 2015-219833), there is disclosed a congestion degree estimation system including a plurality of wearable terminals and a congestion degree estimation server. After the congestion degree estimation server receives a photographic image and image information from a wearable terminal, the congestion degree estimation server calculates a congestion degree by estimating the number of persons and an area of a sidewalk from the photographic image by image analysis. The congestion degree estimation server records the calculated congestion degree together with a location at which the photographic image is taken in a congestion degree table. The congestion degree estimation server maps the congestion degree recorded in the congestion degree table on a map in a map database to create a point group congestion degree map and an area congestion degree map. These data are transmitted in response to a request from the wearable terminal.

Further, in patent literature 2 (Japanese Patent Application Laid-Open No. 2016-36083), there is disclosed a wireless terminal which can acquire information of an access network side by a notification signal or a response signal transmitted from a relay device via a wireless network. This wireless terminal acquires at least one of information about a use degree of a wireless resource and information about a remaining resource capacity of the relay device from the received notification signal or response signal and determines a backhaul congestion degree parameter on the basis of the acquired information. This wireless terminal calculates a maximum window size that specifies an amount of data to be collectively transmitted or received on the basis of the determined backhaul congestion degree parameter. This wireless terminal controls all the window sizes according to at least one of transmission and reception so as to have a value in the maximum window size.

Further, in patent literature 3 (Japanese Patent Application Laid-Open No. 2016-12866), there is disclosed a portable terminal device which determines whether or not a current location of an own device is in a specific area. When this portable terminal device determines that the current location of the own device is in the specific area, the portable terminal device requests a communication speed measurement device in the specific area to measure a communication speed. The communication speed measurement device transmits a signal for communication speed measurement used for communication speed measurement to this portable terminal device. When this portable terminal device determines that the current location of the own device is not in the specific area, this portable terminal device stops the transmission of the signal for communication speed measurement.

### SUMMARY

Information indicating the above-mentioned congestion situation related to communication environment is very useful information when the mobile phone business operator, the ASP, or the like performs a traffic analysis. By improving traffic analysis accuracy, the mobile phone business operator, the ASP, or the like can improve the accuracy in designing a base station or designing a service model to a user.

Generally, the information indicating such congestion situation related to communication environment can be obtained by collecting location information (position information) obtained by each information terminal device using a satellite positioning system GNSS (Global Navigation Satellite System). However, in this case, generally, the information terminal device by which a certain mobile phone business operator can collect the location information is only the information terminal device connected to a wireless communication network operated by this certain mobile phone business operator. Accordingly, this operator cannot collect the information from the information terminal device connected to the wireless communication network operated by another operator.

Further, generally, because all the communication terminal devices do not necessarily make a function to transmit the location information obtained by the GNSS to the outside valid, there is a possibility that the congestion situation obtained by collecting the location information from each information communication terminal differs from an actual congestion situation related to communication environment. Namely, it cannot be said that the information indicating the congestion situation related to communication environment obtained by collecting the location information acquired by each information terminal device is highly accurate information. Accordingly, a problem is to efficiently collect information required for evaluating the congestion situation related to communication environment at a high accuracy. In patent literatures 1 to 3, this problem is not noted. A main object of the invention of the present application is to provide a congestion information transmission terminal device or the like which solves such problem.

A congestion information transmission terminal device according to one aspect of the invention of the present application includes a location information acquisition unit for acquiring location information indicating a location of an own device, an output unit for outputting input request information for prompting a user to input first congestion information indicating a result of an evaluation performed by the user with respect to a congestion situation of people around, a first congestion information acquisition unit for acquiring the first congestion information by the user's input operation in response to the input request information, and a transmission unit for transmitting the location information acquired by the location information acquisition means and the first congestion information acquired by the first congestion information acquisition means to a congestion situation evaluation device which evaluates a congestion situation related to communication environment.

From another viewpoint of attaining the above-mentioned object, a congestion situation evaluation method according to one aspect of the invention of the present application includes: acquiring location information indicating a location of a congestion information transmission terminal device by an own device, outputting input request information for prompting a user to input congestion information indicating a result of an evaluation performed by the user with respect to a congestion situation of people around, acquiring the congestion information by the user's input operation in response to the input request information, transmitting the acquired location information and congestion information to a congestion situation evaluation device, and evaluating the congestion situation related to communication environment by the congestion situation evaluation device on the basis of the location information and the congestion information that are received from the congestion information transmission terminal device.

Additionally, from further viewpoint of attaining the above-mentioned object, a congestion information transmission program according to one aspect of the invention of the present application is a program which causes a computer to perform a location information acquisition processing in which location information indicating a location of the computer is acquired, an output processing in which input request information for prompting a user to input congestion information indicating a result of an evaluation performed by the user with respect to a congestion situation of people around is outputted, a congestion information acquisition processing in which the congestion information is acquired by the user's input operation in response to the input request information, and a transmission processing in which the location information acquired by the location information acquisition processing and the congestion information acquired by the congestion information acquisition processing are transmitted to a congestion situation evaluation device which evaluates a congestion situation related to communication environment.

Further, the invention of the present application can also be realized by a computer-readable non-transitory recording medium storing the congestion information transmission program (computer program).

The invention of the present application enables an efficient collection of information required for evaluating the congestion situation related to communication environment at a high accuracy.

### BRIEF DESCRIPTION OF THE DRAWINGS

FIG. 1 is a block diagram illustrating a configuration of a congestion situation evaluation system 1 according to a first example embodiment of the invention of the present application.

FIG. 2 is a figure illustrating an example of a congestion situation entry screen displayed on a display screen 14 by an output unit 13 according to a first example embodiment of the invention of the present application.

FIG. 3 is a flowchart showing an operation of a congestion situation evaluation system 1 according to a first example embodiment of the invention of the present application.

FIG. 4 is a block diagram illustrating a configuration of a congestion information transmission terminal device 40 according to a second example embodiment of the invention of the present application.

FIG. 5 is a block diagram illustrating a configuration of an information processing device 900 which can carry out a terminal device or a congestion information transmission terminal device according to each example embodiment of the invention of the present application.

### EXAMPLE EMBODIMENT

An example embodiment of the invention of the present application will be described in detail below with reference to a drawing.

### First Example Embodiment

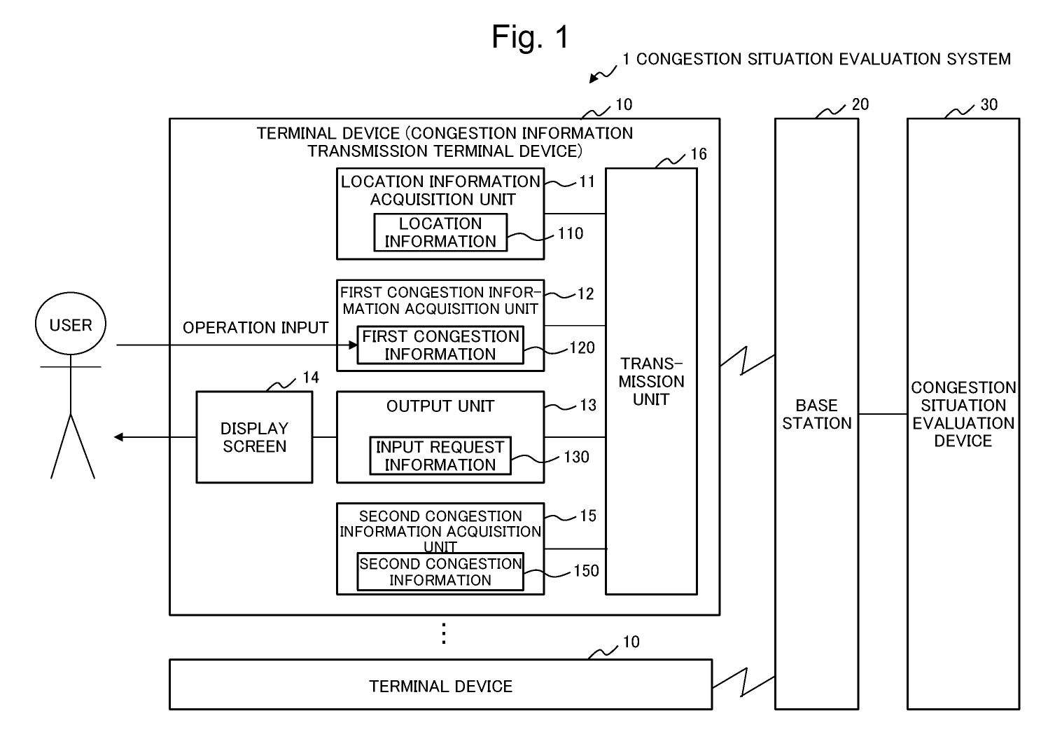

FIG. 1 is a block diagram conceptually illustrating a configuration of a congestion situation evaluation system 1 according to a first example embodiment of the invention of the present application. The congestion situation evaluation system 1 is composed, in rough classification, of one or more terminal devices (congestion information transmission terminal devices) 10, a base station 20, and a congestion situation evaluation device 30. For example, the terminal device 10 is an information terminal device having a wireless communication function such as a smart phone, a tablet terminal device, a wearable terminal device, or the like. The base station 20 accommodates wireless communications by one or more terminal devices 10. The base station 20 is a base station for controlling communications, for example, for GPRS (General Packet Radio Service), UMTS (Universal Mobile Telecommunications System), LTE (Long Term Evolution), LTE-A (LTE-Advanced), 5G (5 Generation), and the like. Alternatively, the base station 20 may be a base station for controlling communications for WiMAX (Worldwide Interoperability for Microwave Access: registered trademark), WiFi (registered trademark), and the like. The congestion situation evaluation device 30 is, for example, an information processing device such as a server device or the like and a device that evaluates the congestion situation related to communication environment used by the terminal device 10 on the basis of information received from one or more terminal devices 10 via the base station 20.

The terminal device 10 according to this example embodiment includes a location information acquisition unit 11, a first congestion information acquisition unit 12, an output unit 13, a display screen 14, a second congestion information acquisition unit 15, and a transmission-reception unit 16. For example, the location information acquisition unit 11, the first congestion information acquisition unit 12, the output unit 13, the second congestion information acquisition unit 15, and the transmission-reception unit 16 may be realized by a congestion evaluation application executed in the terminal device 10.

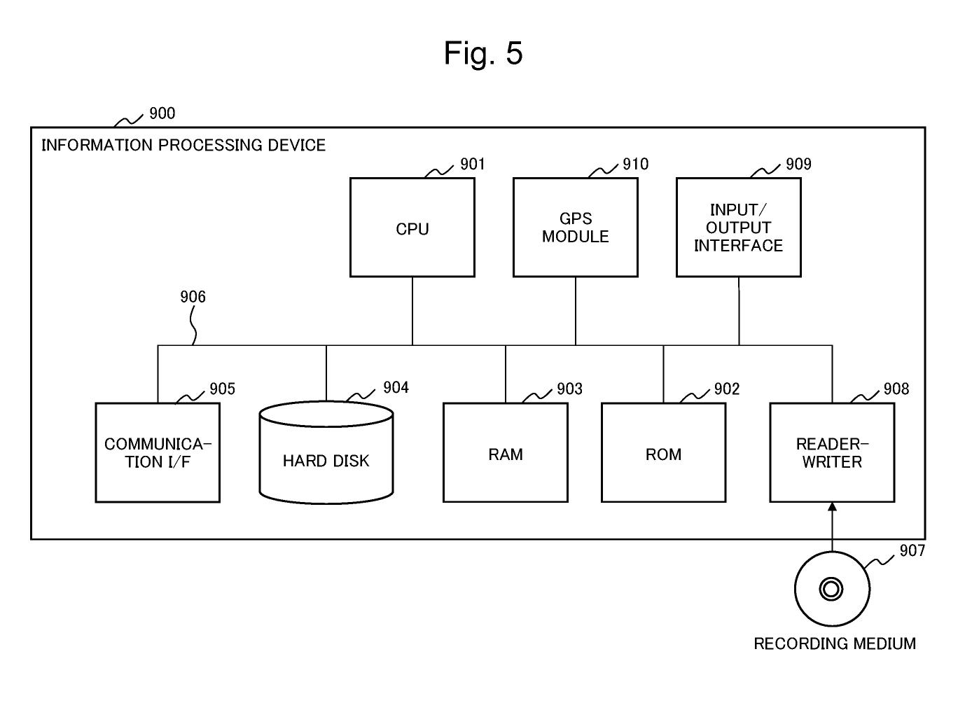

The output unit 13 displays (outputs or presents) input request information 130 on the display screen 14 at a predetermined timing T1. For example, the timing T1 is a timing indicated by timing setting information previously stored in a memory (for example, a ROM 902, a RAM 903, or the like shown in FIG. 5 described later) in the terminal device 10. Alternatively, the timing T1 may be a timing at which the transmission-reception unit 16 described later receives a signal for requesting transmission of location information (position information) 110, first congestion information 120, and the like from the congestion situation evaluation device 30. The input request information 130 is information for prompting a user to input information indicating a result of an evaluation performed by the user that uses the terminal device 10 with respect to a congestion situation of people around.

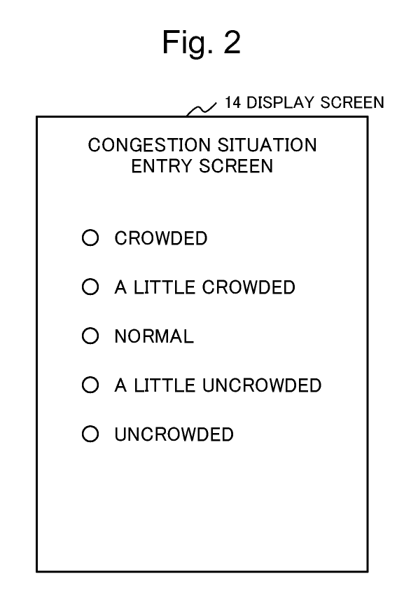

FIG. 2 is a figure illustrating an example of a congestion situation entry screen (the input request information 130) displayed on the display screen 14 by the output unit 13 according to this example embodiment. As exemplarily illustrated in FIG. 2, candidate values on a five-stage scale: “crowded”, “a little crowded”, “normal”, “a little uncrowded”, and “uncrowded” that show a degree of the congestion situation of people around and radio buttons for showing the selected candidate value are displayed on the display screen 14. The input request information 130 displayed on the display screen 14 by the output unit 13 is not limited to the congestion situation entry screen exemplarily illustrated in FIG. 2. The input request information 130 may include the candidate values on a plural-stage scale other than the five-stage scale which indicate the degree of the congestion situation of people around. Alternatively, the input request information 130 may include a check box, a text input field, or the like.

A method for presenting the input request information 130 to the user by the output unit 13 is not limited to the above-mentioned method using the display screen 14. For example, the output unit 13 may prompt the user to input the information indicating the result of the evaluation performed by the user.

The first congestion information acquisition unit 12 shown in FIG. 1 acquires the first congestion information 120 by the user performing input operation (for example, the user selects one of the candidate values on the five-stage scale exemplarily illustrated in FIG. 2) according to the congestion situation entry screen displayed on the display screen 14. Namely, the first congestion information 120 is information indicating a result of a visual evaluation performed by the user with respect to the congestion situation of people around. For example, when the terminal device 10 is a smart phone, the user inputs the first congestion information 120 to the first congestion information acquisition unit 12 by using a touch panel function provided on the display screen 14. The first congestion information acquisition unit 12 inputs the acquired first congestion information 120 to the transmission-reception unit 16 together with a value indicating a timing T2 at which the first congestion information 120 is acquired.

The location information acquisition unit 11 shown in FIG. 1 acquires (measures) the location information 110 indicating the location of the terminal device 10, for example, at the timing T2 by using the satellite positioning system GNSS. The location information acquisition unit 11 inputs the acquired location information 110 to the transmission-reception unit 16.

For example, the second congestion information acquisition unit 15 has a function to perform D2D (Device to Device) communication with one or more other terminal devices 10 (other devices) capable of being accessed by D2D communication and are located in the vicinity of an own device. The D2D communication is communication performed between two terminal devices 10 directly without using the base station 20. For example, the second congestion information acquisition unit 15 acquires second congestion information 150 by performing D2D communication with one or more other terminal devices 10 at the timing T2. The second congestion information 150 is information indicating a situation in which another terminal device 10 exists in the vicinity and includes, for example, the number of the other terminal devices 10 that the second congestion information acquisition unit 15 can access by the D2D communication. The second congestion information acquisition unit 15 inputs the acquired second congestion information 150 to the transmission-reception unit 16.

When the transmission-reception unit 16 receives a signal for requesting transmission of the location information 110, the first congestion information 120, and the like from the congestion situation evaluation device 30 at the timing T1, the transmission-reception unit 16 inputs the received signal to the output unit 13.

The transmission-reception unit 16 transmits the first congestion information 120 and the value indicating the timing T2 that are inputted from the first congestion information acquisition unit 12, the second congestion information 150 inputted from the second congestion information acquisition unit 15, and the location information 110 inputted from the location information acquisition unit 11 to the congestion situation evaluation device 30 via the base station 20. The transmission-reception unit 16 may transmit these information written in a report form of MDT (Minimization of Drive Tests) or the like defined in the 3GPP (Third Generation Partnership Project) standards to the congestion situation evaluation device 30.

The congestion situation evaluation device 30 evaluates the congestion situation related to communication environment in which the terminal device 10 is used on the basis of the first congestion information 120 received from one or more terminal devices 10, the value indicating the timing T2, the second congestion information 150, and the location information 110. More specifically, for example, the congestion situation evaluation device 30 evaluates the congestion situation of communication environment with respect to the vicinity of a place indicated by the location information 110 at a time indicated by the timing T2 on the basis of the value indicated by the first congestion information 120 and the second congestion information 150. However, it is assumed that the congestion situation evaluation device 30 has a standard (for example, a database in which the value indicated by the first congestion information 120 and the second congestion information 150 is associated with the value indicating the congestion situation of communication environment or the like) for evaluating the congestion situation of communication environment on the basis of the value indicated by the first congestion information 120 and the second congestion information 150.

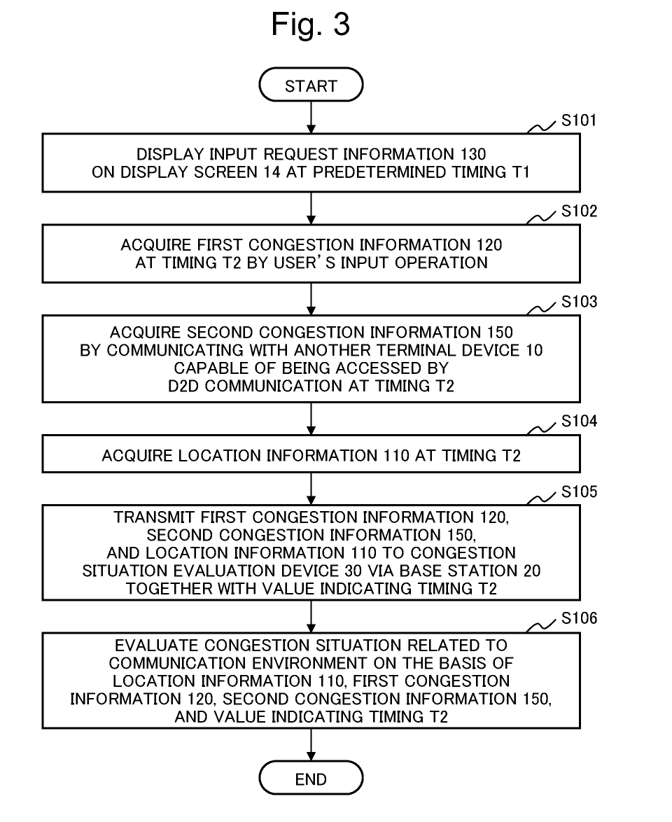

Next, an operation (processing) of the congestion situation evaluation system 1 according to this example embodiment will be described in detail with reference to a flowchart shown in FIG. 3.

The output unit 13 of the terminal device 10 displays the input request information 130 on the display screen 14 at the predetermined timing T1 (step S101). The first congestion information acquisition unit 12 acquires the first congestion information 120 at the timing T2 by user's input operation and inputs the acquired first congestion information 120 and the value indicating the timing T2 to the transmission-reception unit 16 (step S102). The second congestion information acquisition unit 15 acquires the second congestion information 150 by communicating with another terminal device 10 capable of being accessed by the D2D communication at the timing T2 and inputs the acquired second congestion information 150 to the transmission-reception unit 16 (step S103).

The location information acquisition unit 11 acquires the location information 110 at the timing T2 and inputs the acquired location information 110 to the transmission-reception unit 16 (step S104). The transmission-reception unit 16 transmits the first congestion information 120, the second congestion information 150, and the location information 110 to the congestion situation evaluation device 30 via the base station 20 together with the value indicating the timing T2 (step S105). The congestion situation evaluation device 30 evaluates the congestion situation related to communication environment on the basis of the location information 110 received from one or more terminal devices 10, the first congestion information 120, the second congestion information 150, and the value indicating the timing T2 (step S106), and all the processes end.

The terminal device 10 according to this example embodiment can efficiently collect information required to evaluate the congestion situation related to communication environment at a high accuracy. This is because the terminal device 10 prompts the user to perform input operation of the result of the evaluation with respect to the congestion situation of people around by outputting the input request information 130 and transmits the first congestion information 120 acquired by the input operation to the congestion situation evaluation device 30.

An effect realized by the congestion situation evaluation system 1 according to this example embodiment will be described in detail below.

Generally, the information indicating the congestion situation related to communication environment can be obtained by collecting the location information obtained by each information terminal device using the GNSS. However, in this case, the information terminal device of which a certain mobile phone business operator can collect the location information is only the information terminal device connected to a wireless communication network operated by the certain mobile phone business operator and the certain mobile phone business operator cannot collect information with respect to the information terminal device connected to the wireless communication network operated by another operator. Further, generally, because all the communication terminal devices do not necessarily make a function to transmit the location information obtained by the GNSS to the outside valid, there is a possibility that the congestion situation obtained by collecting the location information from each information communication terminal is different from an actual congestion situation related to communication environment. Namely, there is a problem that the information indicating the congestion situation related to communication environment obtained by collecting the location information obtained by each information terminal device is not necessarily information with high accuracy.

Against such problem, the terminal device 10 according to this example embodiment includes the location information acquisition unit 11, the first congestion information acquisition unit 12, the output unit 13, and the transmission-reception unit 16. Namely, the location information acquisition unit 11 acquires the location information 110 indicating the position of the terminal device 10. The output unit 13 outputs the input request information 130 for prompting the user to input the first congestion information 120 indicating the result of the evaluation performed by the user with respect to the congestion situation of people around. The first congestion information acquisition unit 12 acquires the first congestion information 120 by user's input operation in response to the input request information 130. The transmission-reception unit 16 transmits the location information 110 acquired by the location information acquisition unit 11 and the first congestion information 120 acquired by the first congestion information acquisition unit 12 to the congestion situation evaluation device 30 which evaluates the congestion situation related to communication environment.

Namely, the first congestion information 120 obtained by user's input operation is information indicating the result of subjectively evaluating the congestion situation of people around by the user. In this case, as described above, the first congestion information 120 is information including the information of the information terminal device connected to the wireless communication network operated by another operator, the information terminal device of which the function to transmit the location information obtained by the GNSS to the outside is not made valid, and the like. Accordingly, it can be said that the first congestion information 120 is information with high accuracy indicating the congestion situation. Therefore, the terminal device 10 according to this example embodiment can efficiently collect the information required to evaluate the congestion situation related to communication environment at a high accuracy.

Further, the terminal device 10 according to this example embodiment further includes the second congestion information acquisition unit 15 and by communicating with another terminal device 10 capable of being accessed by the D2D communication, acquires the second congestion information 150 indicating a situation in which another terminal device 10 exists in the vicinity. The congestion situation evaluation device 30 according to this example embodiment evaluates the congestion situation related to communication environment on the basis of both the first congestion information 120 and the second congestion information 150. Hereby, the congestion situation evaluation system 1 according to this example embodiment can evaluate the congestion situation related to communication environment at a higher degree of accuracy.

Further, the input request information 130 outputted by the output unit 13 according to this example embodiment includes a plurality of candidate values indicating a degree of the congestion situation of people around, for example, as exemplarily illustrated in FIG. 2. The first congestion information acquisition unit 12 acquires a specific candidate value selected from among the plurality of the candidate values by the user as the first congestion information 120. Namely, by simplifying the user's input operation, the terminal device 10 according to this example embodiment can acquire the first congestion information 120 without imposing a burden on the user.

Further, the congestion situation evaluation device 30 according to this example embodiment may have a function to transmit a signal for requesting the location information 110 and the first congestion information 120 (the second congestion information 150 may be included) to a specific terminal device 10 on the basis of the location information 110 and the first congestion information 120 (the second congestion information 150 may be included) that are received from a plurality of the terminal devices 10. In this case, the congestion situation evaluation device 30 determines whether or not the location information 110 and the first congestion information 120 have to be acquired from another terminal device 10 as additional information in order to further improve the accuracy of the evaluation result based on the result of evaluating the congestion situation related to communication environment on the basis of the location information 110 and the first congestion information 120 that are received from several terminal devices 10. When the congestion situation evaluation device 30 determines that the additional information has to be acquired, the congestion situation evaluation device 30 acquires the location information 110 and the first congestion information 120 from the another terminal device 10. Hereby, the congestion situation evaluation system 1 according to this example embodiment can evaluate the congestion situation related to communication environment at a higher degree of accuracy.

Further, the congestion situation evaluation device 30 according to this example embodiment may transmit the result of evaluating the congestion situation related to communication environment to the terminal device 10 or disclose it by using a Web server device (not shown). In this case, for example, the congestion situation evaluation system 1 can increase the number of the users who install a congestion evaluation application executed in the terminal device 10 to the terminal device 10 and activate it. As a result, the congestion situation evaluation system 1 according to this example embodiment can evaluate the congestion situation related to communication environment at a higher degree of accuracy.

Further, the base station 20 according to this example embodiment may have a function to set a parameter value for controlling communication on the basis of the location information 110 and the first congestion information 120 (the second congestion information 150 may be included) that can be obtained when the communication between the terminal device 10 and the congestion situation evaluation device 30 is relayed. By this function, the congestion situation evaluation system 1 according to this example embodiment can dynamically and flexibly set the communication environment to the most suitable state on the basis of the congestion situation related to current communication environment.

Further, there is a case in which the terminal device 10 according to this example embodiment does not include the second congestion information acquisition unit 15. Furthermore, there is a case in which the transmission-reception unit 16 according to this example embodiment does not transmit the value indicating the timing T2 to the congestion situation evaluation device 30. In this case, the congestion situation evaluation device 30 may use a value or the like indicating a timing at which the location information 110 and the first congestion information 120 are received from the terminal device 10 instead of the value indicating the timing T2.

### Second Example Embodiment

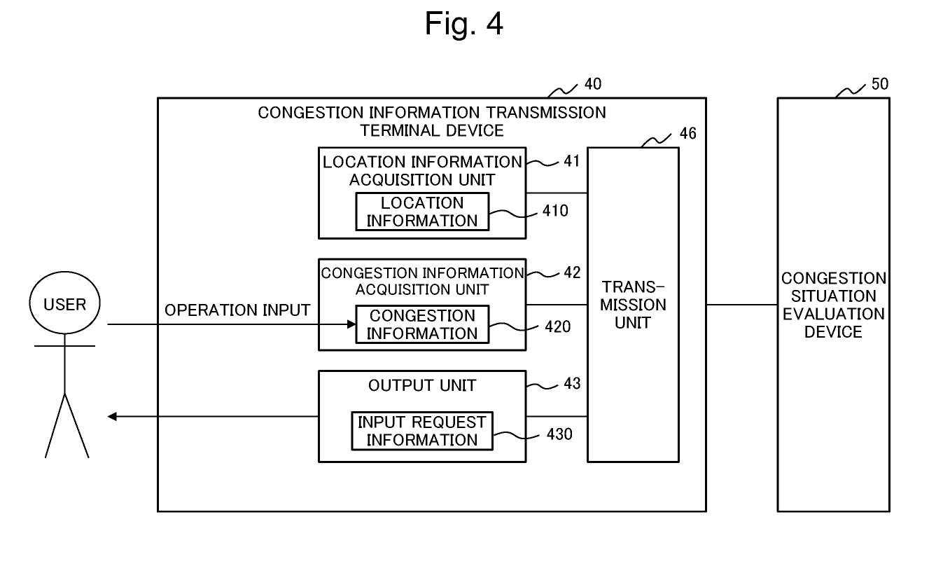

FIG. 4 is a block diagram conceptually illustrating a configuration of a congestion information transmission terminal device 40 according to a second example embodiment of the invention of the present application.

The congestion information transmission terminal device 40 according to this example embodiment includes a location information acquisition unit 41, a congestion information acquisition unit 42, an output unit 43, and a transmission unit 46.

The location information acquisition unit 41 acquires location information 410 indicating a location of an own device (the congestion information transmission terminal device 40).

The output unit 43 outputs input request information 430 for prompting the user to input congestion information 420 indicating a result of the evaluation performed by the user with respect to the congestion situation of people around.

The congestion information acquisition unit 42 acquires the congestion information 420 by the user's input operation in response to the input request information 430.

The transmission unit 46 transmits the location information 410 acquired by the location information acquisition unit 41 and the congestion information 420 acquired by the congestion information acquisition unit 42 to the congestion situation evaluation device 50 that evaluates a congestion situation related to communication environment.

The congestion information transmission terminal device 40 according to this example embodiment can efficiently collect information required to evaluate the congestion situation related to communication environment at a high accuracy. This is because the congestion information transmission terminal device 40 prompts the user to perform input operation of the result of the evaluation with respect to the congestion situation of people around by outputting the input request information 430 and transmits the congestion information 420 acquired by the input operation to a congestion situation evaluation device 50.

[Example of Hardware Configuration]

In each example embodiment described above, each unit of the terminal device 10 shown in FIG. 1 and the congestion information transmission terminal device 40 shown in FIG. 4 can be realized by dedicated HW (HardWare) (electronic circuit). Further, in FIG. 1 and FIG. 4, at least, the following configuration can be thought of as a function (processing) unit (software module) of a software program.

The location information acquisition units 11 and 41

The first congestion information acquisition unit 12 and the congestion information acquisition unit 42

The output units 13 and 43

The second congestion information acquisition unit 15

The transmission-reception unit 16 and the transmission unit 46.

However, segmentation of each unit shown in these drawings is a configuration for convenience of explanation. In actually installing each unit, various configuration can be expected. An example of hardware environment in this case will be described with reference to FIG. 5.

FIG. 5 is a figure exemplarily explaining a configuration of an information processing device 900 (computer) which can carry out the terminal device or the congestion information transmission terminal device according to each example embodiment of the invention of the present application. Namely, FIG. 5 illustrates a configuration of a computer (information processing device) which can realize the terminal device shown in FIG. 1 and the congestion information transmission terminal device shown in FIG. 4 or a part of these devices and shows hardware environment that can realize each function in the above-mentioned example embodiment. The information processing device 900 shown in FIG. 5 includes the followings as a component.

A CPU (Central_Processing_Unit) 901

A ROM (Read_Only_Memory) 902

A RAM (Random_Access_Memory) 903

A hard disk (storage device) 904

A communication interface 905 with an external device such as a wireless transmission-reception unit or the like

A bus 906 (communication wire)

A reader-writer 908 which can read and write data stored in recording media 907 such as a CD-ROM (Compact_Disc_Read_Only_Memory) and the like

An input/output interface 909 such as a display, a keyboard, or the like

A GPS (Global_Positioning_System) module 910.

Namely, the information processing device 900 equipped with the above-mentioned components is a common computer in which these components are connected via the bus 906. There may be a case in which the information processing device 900 includes a plurality of the CPUs 901 or a case in which the information processing device 900 includes the CPU 901 composed of a multi-core.

The invention of the present application which has been described by using the above-mentioned example embodiment as an example provides a computer program which can realize the following function to the information processing device 900 shown in FIG. 5. Its function is a function of the above-mentioned configuration shown in the block diagram (FIG. 1 and FIG. 4) referred to in the explanation of the example embodiment or the flowchart (FIG. 3). The invention of the present application is achieved by reading the computer program, storing it in the CPU 901 of hardware, interpreting it, and executing it. Further, the computer program provided in the device may be stored in a readable-writable volatile memory (RAM 903) or a non-volatile storage device such as the ROM 902, the hard disk 904, or the like.

Further, in the above-mentioned case, as a method for providing the computer program in the hardware, a currently common procedure can be adopted.

As the procedure, for example, a method in which it is installed in the device via the various recording media 907 such as a CD-ROM and the like, a method in which it is downloaded from the outside via a communication line such as the internet or the like, or another method can be used. In such case, the invention of the present application can be thought of being composed of a code of which the computer program is composed or the recording media 907 storing its code.

While the present invention has been particularly shown and described with reference to example embodiments thereof, the invention is not limited to these embodiments. It will be understood by those of ordinary skill in the art that various changes in form and details may be made therein without departing from the spirit and scope of the present invention as defined by the claims.

Further, it is noted that the inventor's intent is to retain all equivalents of the claimed invention even when the claims are amended during prosecution.

1. A congestion information transmission terminal device comprising:
a location information acquisition unit configured to acquire location information indicating a location of an own device;
an output unit configured to output input request information for prompting a user to input first congestion information indicating a result of an evaluation performed by the user with respect to a congestion situation of people around;
a first congestion information acquisition unit configured to acquire the first congestion information by the user's input operation in response to the input request information; and
a transmission unit configured to transmit the location information acquired by the location information acquisition unit and the first congestion information acquired by the first congestion information acquisition unit to a congestion situation evaluation device which evaluates a congestion situation related to communication environment.

2. The congestion information transmission terminal device according to claim 1, wherein
the output unit outputs the input request information, on the basis of timing setting information stored in the own device, in which a timing at which the input request information is outputted is set, or being requested by the congestion situation evaluation device.

3. The congestion information transmission terminal device according to claim 1, wherein
the congestion information transmission terminal device further comprises a second congestion information acquisition unit configured to acquire second congestion information indicating a situation in which another device exists in a vicinity by communicating with the another device capable of being accessed by D2D communication, and
the transmission unit transmits the second congestion information acquired by the second congestion information acquisition unit to the congestion situation evaluation device.

4. The congestion information transmission terminal device according to claim 1, wherein
the transmission unit transmits a timing at which the first congestion information acquisition unit acquires the first congestion information to the congestion situation evaluation device.

5. The congestion information transmission terminal device according to claim 1, wherein
the input request information includes a plurality of candidate values indicating a degree of the congestion situation of people around, and
the first congestion information acquisition unit acquires a specific candidate value, as the first congestion information, which is selected by the user from among a plurality of the candidate values.

6. A congestion situation evaluation system comprising:
a congestion information transmission terminal device including;
a location information acquisition unit configured to acquire location information indicating a location of an own device,
an output unit configured to output input request information for prompting a user to input first congestion information indicating a result of an evaluation performed by the user with respect to a congestion situation of people around,
a first congestion information acquisition unit configured to acquire the first congestion information by the user's input operation in response to the input request information, and
a transmission unit configured to transmit the location information acquired by the location information acquisition unit and the first congestion information acquired by the first congestion information acquisition unit to a congestion situation evaluation device which evaluates a congestion situation related to communication environment; and
the congestion situation evaluation device which evaluates the congestion situation related to the communication environment on the basis of the location information and the first congestion information that are received from the congestion information transmission terminal device.

7. The congestion situation evaluation system according to claim 6 further comprising:
a base station which relays communication between the congestion information transmission terminal device and the congestion situation evaluation device, and sets a parameter value controlling the communication on the basis of the location information and the first congestion information that are received from the congestion information transmission terminal device.

8. The congestion situation evaluation system according to claim 6, wherein
the congestion situation evaluation device requests the location information and the first congestion information to a specific congestion information transmission terminal device on the basis of the location information and the first congestion information that are received from a plurality of the congestion information transmission terminal devices.

9. A congestion situation evaluation method comprising:
by a congestion information transmission terminal device,
acquiring location information indicating a location of an own device,
outputting input request information for prompting a user to input congestion information indicating a result of an evaluation performed by the user with respect to a congestion situation of people around,
acquiring the congestion information by the user's input operation in response to the input request information, and
transmitting the acquired location information and congestion information to a congestion situation evaluation device; and
by the congestion situation evaluation device,
evaluating the congestion situation related to communication environment on the basis of the location information and the congestion information that are received from the congestion information transmission terminal device.

10. A non-transitory computer readable recording medium storing a congestion information transmission program which causes a computer to perform:
a location information acquisition processing that acquires location information indicating a location of the computer;
an output processing that outputs input request information for prompting a user to input congestion information indicating a result of an evaluation performed by the user with respect to a congestion situation of people around;
a congestion information acquisition processing that acquires the congestion information by the user's input operation in response to the input request information; and
a transmission processing that transmits the location information acquired by the location information acquisition processing and the congestion information acquired by the congestion information acquisition processing to a congestion situation evaluation device evaluating a congestion situation related to communication environment.
